(19) United States
(12) Patent Application Publication
(10) Pub. No.: US 2008/0106216 A1
(43) Pub. Date: May 8, 2008

(54) DIMMING METHOD FOR LIGHT-EMITTING DIODES

(75) Inventors: Chien Peng YU, Hsinchu (TW); Yi Cheng WANG, Hsinchu (TW); Ye Hsuan YAN, Hsinchu (TW)

Correspondence Address: EGBERT LAW OFFICES, 412 MAIN STREET, 7TH FLOOR, HOUSTON, TX, 77002, US

(73) Assignee: ADVANCED ANALOG TECHNOLOGY, Inc., Hsinchu (TW)

(21) Appl. No.: 11/670,045

(22) Filed: Feb. 1, 2007

(30) Foreign Application Priority Data
Oct. 18, 2006 (TW) 095138331

(51) Int. Cl. H05B 41/24

(52) U.S. Cl. 315/247

(57) ABSTRACT

A dimming method for light emitting diodes (LEDs), which is applied in a pulse width modulation boost circuit system, includes the following steps: (a) equally dividing a cycle into a plurality of intervals; (b) providing a plurality of control signals having the cycle and a pulse duration, wherein the pulse duration of each of the control signals is sequentially generated in the cycle; and (c) using the plurality of control signals to control a plurality of corresponding switches for dimming the LEDs connected to the switches.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a dimming method for light emitting diodes (LEDs), and more particularly, to a dimming method for the LEDs applied to a pulse width modulation boost circuit system.

2. Description of Related Art Including Information Disclosed Under 37 CFR 1.97 and 37 CFR 1.98

FIG. 1 is a schematic view of a circuit for a conventional LED dimming system 10. The LED dimming system 10 includes a boost circuit 11, a pulse width modulation controller 12, a comparator 13, a feedback signal selector 14, a DPWM signal generator 15, a LED group 17 including six LEDs of LED1-LED6, a switch group 18 including six switches of T1-T6, and a current source group 19 including six current sources of I_{S1}-I_{S6}. The boost circuit 11 includes a voltage source V_{IN}, an input capacitor C1, an output capacitor C2, a diode D, a boost inductor L, a resistor R, and a switch. The boost circuit 11 receives a pulse width modulation signal SG (with a changeable duty cycle) from the pulse width modulation controller 12 to control the output voltage V_{OUT}. According to a current feedback signal I_{SEN} and an output signal of the comparator 13, the pulse width modulation controller 12 timely adjusts the duty cycle of the pulse width modulation signal S_{G}. A control signal DS_{G} generated by the DPWM signal generator 15 is transferred to each switch T1-T6 in the switch group 18, so as to simultaneously control the ON or OFF state of the switches T1-T6. Generally, the forward voltage and the operating current of the white light LED are respectively 3.6 V and 20 mA.

In order to avoid violating the maximum current specification of the white light LED and thereby sacrificing the reliability (thereby speeding up the aging of the white light LED) and to obtain the predictable and mutually matching luminance and chrominance, the white light LED is generally driven by a fixed current source. Therefore, the current sources I_{S1}-I_{S6} in the current source group 19 are respectively connected to the LEDs of LED1-LED6 in the LED group 17 through the switches T1-T6, so as to control the current flowing through the LEDs of LED1-LED6. The feedback signal selector 14 receives the feedback signals FB1-FB6 relevant to the LEDs of LED1-LED6, selects one of the feedback signals FB1-FB6 (for example, the one with the minimum voltage) as the output signal FB0, and transfers it to the comparator 13 to be compared with a reference voltage V_{REF}, in order to control the duty cycle of the pulse width modulation signal S_{G}. The brightness of the LEDs of LED1-LED6 is controlled by the control signal DS_{G}.

FIG. 2 is a timing chart of the control signal DS_{G}, the output current I_{OUT} and the output voltage V_{OUT} of the boost circuit 11. The control signal DS_{G} has a cycle T and a pulse duration P (i.e., time duration when it is at the high logic level). Such pulse duration P is used to simultaneously close the switches T1-T6 to make an operating current (e.g., 20 mA) flow through each LED of LED1-LED6, and thereafter, the LEDs emit lights. At this time, the output current I_{OUT} of the boost circuit 11 is 120 mA (i.e., 20 mA×6). The brightness of the LEDs of LED1-LED6 can be modified by adjusting the duty cycle of the control signal DS_{G} (i.e., the length of the pulse duration P is adjusted).

However, the dimming method used in the conventional LED dimming system 10 has the following disadvantages: (1) the output capacitor C2 of the boost circuit 11 is charged and discharged, so as to generate an excessively large ripple voltage and thereby reducing the service efficiency of the power source; and (2) the dimming method of the boost circuit 11 switches between the totally opened state (with the current value of 120 mA) or the totally closed state (with the current value of zero) of the output current I_{OUT}, and adjusts the ON or OFF time of all the switches T1-T6 according to the duty cycle of the control signal DS_{G} (the ratio of P/T), but not operating in a continuous conduction mode (CCM). The operating method also reduces the service efficiency of the power source.

### BRIEF SUMMARY OF THE INVENTION

An aspect of the present invention is to provide a dimming method for the LEDs, applied in a pulse width modulation boost circuit, wherein a plurality of sequentially generated control signals is used to independently control the corresponding LEDs, so as to reduce the ripple voltage of the output voltage for the pulse width modulation boost circuit, and thereby enhancing the service efficiency of the power source of the pulse width modulation boost circuit.

Another aspect of the present invention is to provide a dimming method for the LEDs, applied in a pulse width modulation boost circuit, wherein a plurality of sequentially generated control signals are used in such pulse width modulation boost circuit to independently control the corresponding LEDs, such that the pulse width modulation boost circuit is operated in a CCM, and thereby enhancing the service efficiency of the power source of the pulse width modulation boost circuit.

The present invention discloses a dimming method for the LEDs, applied in a pulse width modulation boost circuit. The dimming method comprises the following steps of: (a) equally dividing a cycle into a plurality of intervals; (b) providing a plurality of control signals having the cycle and a pulse duration, wherein the pulse duration of each of the control signals is sequentially generated in the cycle; and (c) using the plurality of control signals to control a plurality of corresponding switches for dimming the LEDs connected to the switches.

### BRIEF DESCRIPTION OF THE SEVERAL VIEWS OF THE DRAWINGS

The invention will be described according to the appended drawings.

FIG. 1 is a schematic view of a circuit of a conventional LED dimming system.

FIG. 2 is a timing chart of the signal relevant to FIG. 1.

FIG. 3 is a schematic view of a circuit of a LED dimming system according to an embodiment of the present invention.

FIG. 4 is a timing chart of a control signal relevant to FIG. 3.

FIGS. 5(a)-5(c) are timing charts of the signal relevant to FIG. 3 under duty cycles of different control signals.

### DETAILED DESCRIPTION OF THE INVENTION

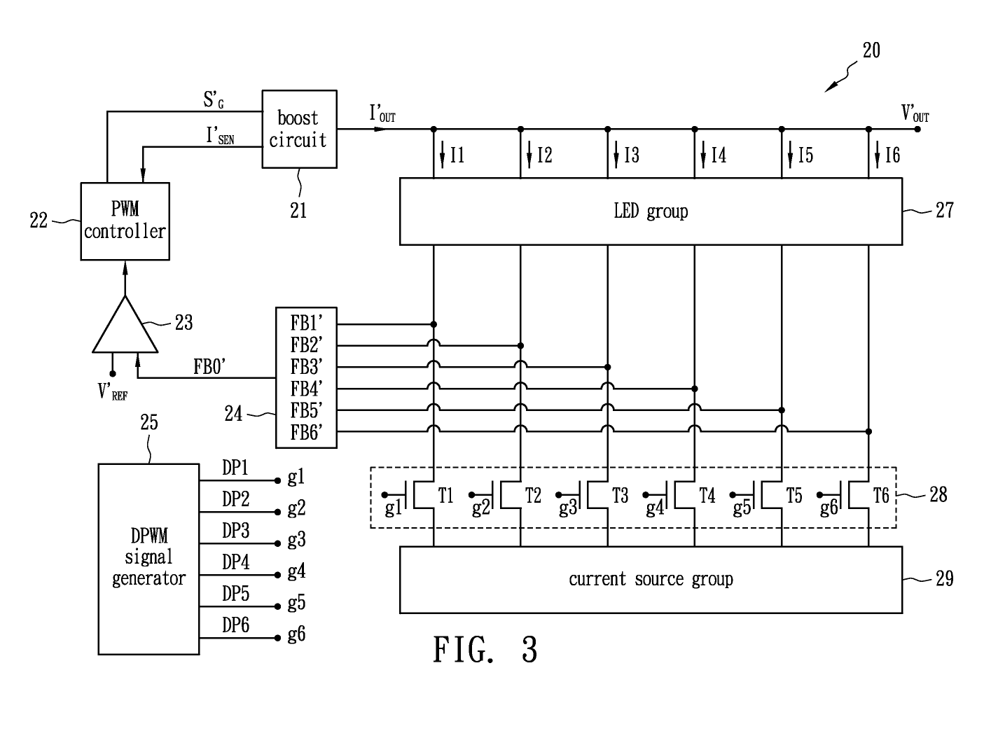

FIG. 3 is a schematic view of a circuit of the LED dimming system 20 in the dimming method for the LED according to an embodiment of the present invention. The dimming system 20 includes a boost circuit 21, a pulse width modulation controller 22, a comparator 23, a feedback signal selector 24, a DPWM signal generator 25, a LED group 27 including six LEDs (not shown), a switch group 28 including six switches T1-T6 (MOS transistor is used as the switch in this embodiment), and a current source group 29 including six current sources (not shown).

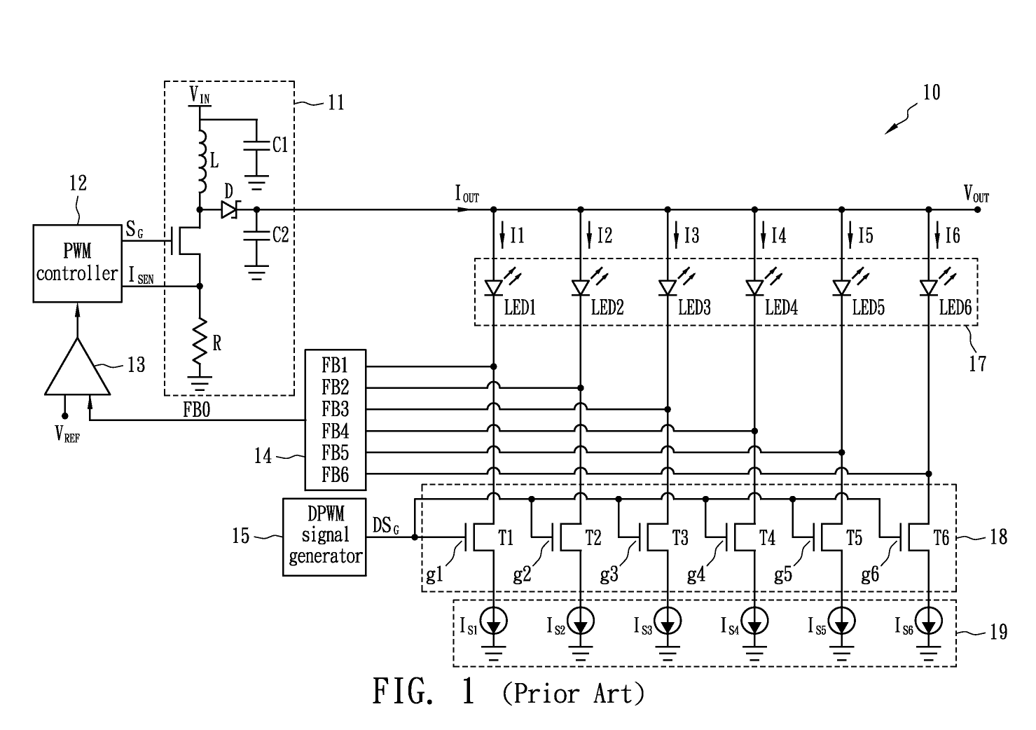

The operating principle of the dimming system 20 is described herein. The boost circuit 21 receives a pulse width modulation signal S′_{G} (with a changeable duty cycle) from the pulse width modulation controller 22 to control the output voltage V′_{OUT}. According to the current feedback signal I′_{SEN} and the output signal of the comparator 23, the pulse width modulation controller 22 timely adjusts the duty cycle of the pulse width modulation signal S′_{G}. The six control signals DP1-DP6 generated by the DPWM signal generator 25 are respectively transferred to the gates g1-g6 of each switch T1-T6 in the switch group 28, so as to sequentially control the ON or OFF state of the switches T1-T6. The six current sources in the current source group 29 are respectively connected to the six LEDs in the LED group 27 through the switches T1-T6 (the connecting method is same as that of FIG. 1), in order to control the current flowing through the six LEDs. The feedback signal selector 24 receives the feedback signals FB1′-FB6′ relevant to the six LEDs, selects one of the feedback signals FB1′-FB6′ (for example, the one with the minimum voltage) as the output signal FB0′, and then transfers it to the comparator 23 to be compared with a reference voltage V′_{REF}, and thereby controls the duty cycle of the pulse width modulation signal S′_{G}. The brightness of the six LEDs is controlled by the control signals DP1-DP6.

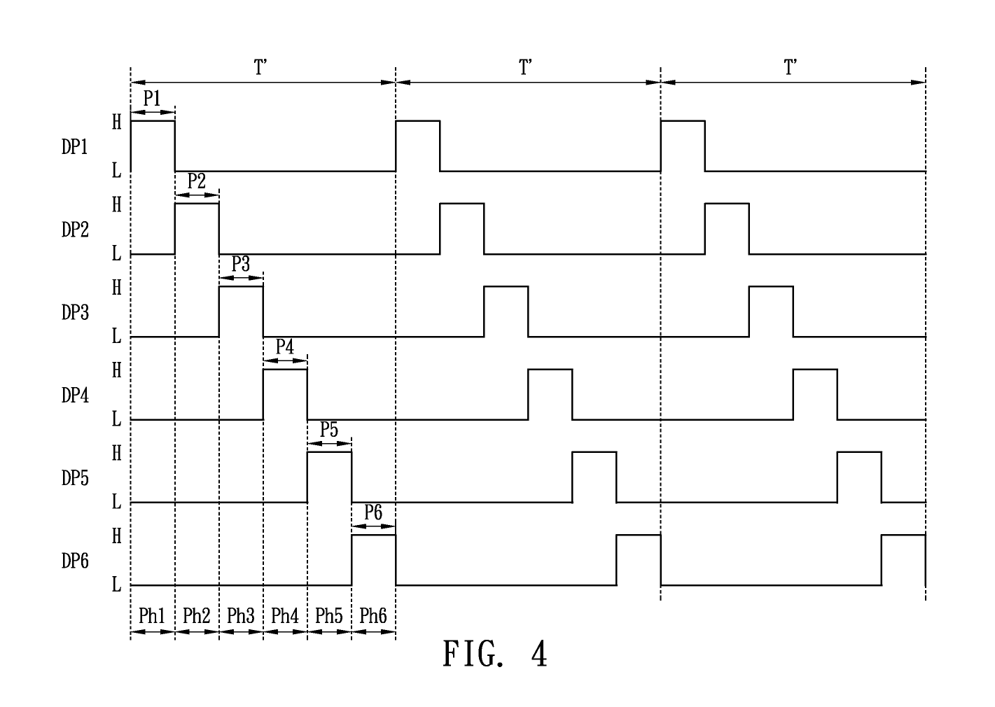

FIG. 4 is a timing chart of the control signals DP1-DP6 of the dimming method for the LED according to an embodiment of the present invention. First, a clock signal having a cycle T′ is provided. Next, the cycle T′ is equally divided into six intervals Ph1-Ph6. Then, the DPWM signal generator 25 provides six control signals DP1-DP6, each having the same cycle T′ and having a pulse duration P1-P6 respectively (in this embodiment, the six pulse durations P1-P6 are the same). The six pulse durations P1-P6 are sequentially generated in the cycle T′ and respectively transferred to the gates g1-g6 of the six switches T1-T6. Therefore, the six pulse durations P1-P6 are corresponding to the operating currents I1-I6 flowing through the six LEDs. In addition, the six control signals DP1-DP6 are generated by the clock signal (with the cycle of T′) and a time-delay circuit. It should be noted in this embodiment that, the six control signals DP1-DP6 have the same duty cycle, i.e., P1/T′, and it is referred to as the control signal duty cycle below.

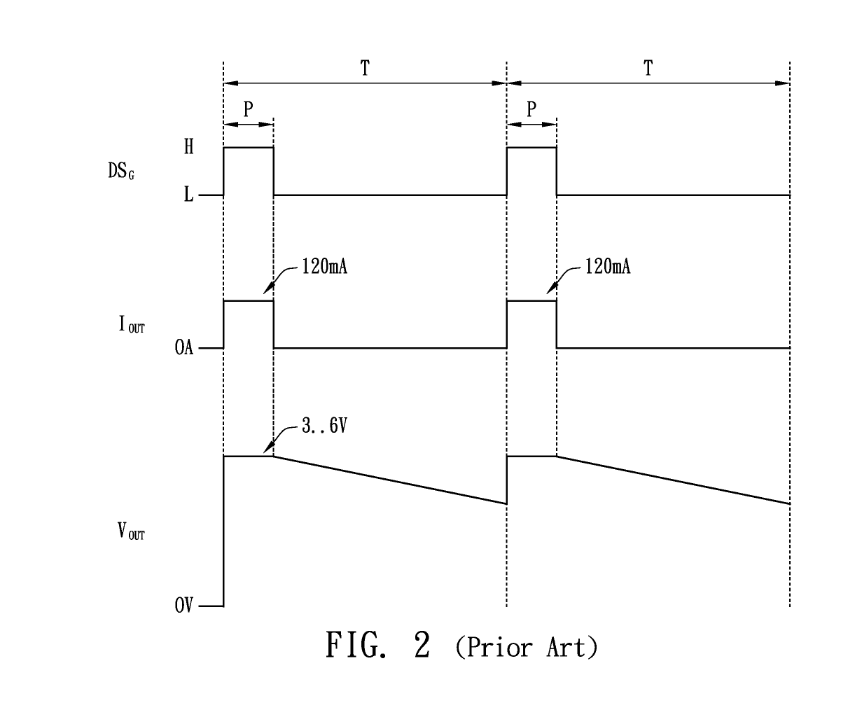

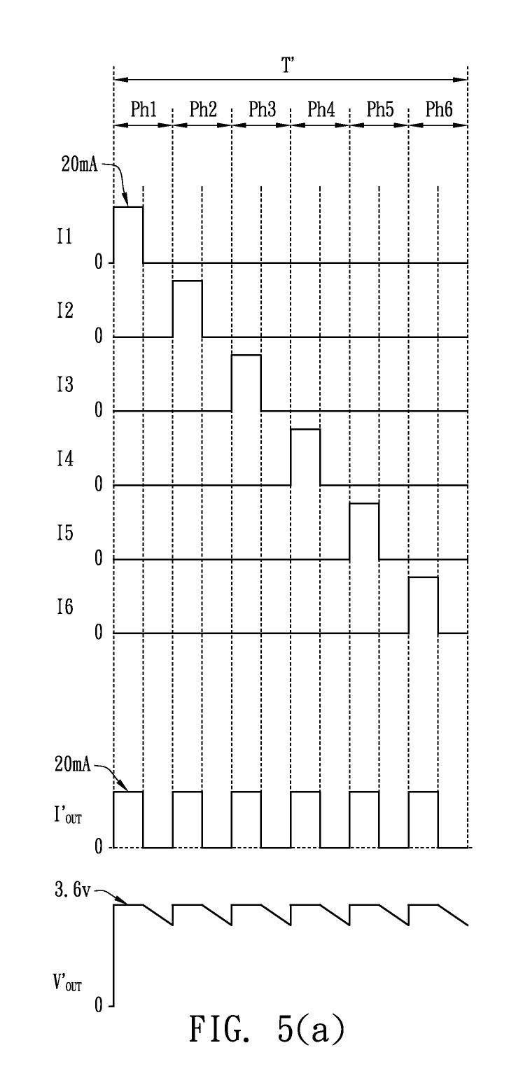

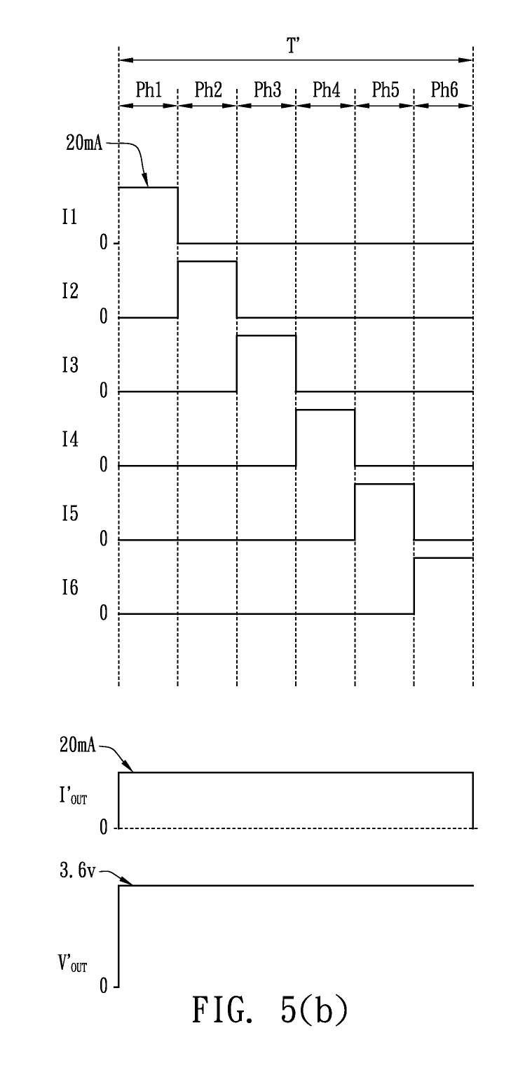

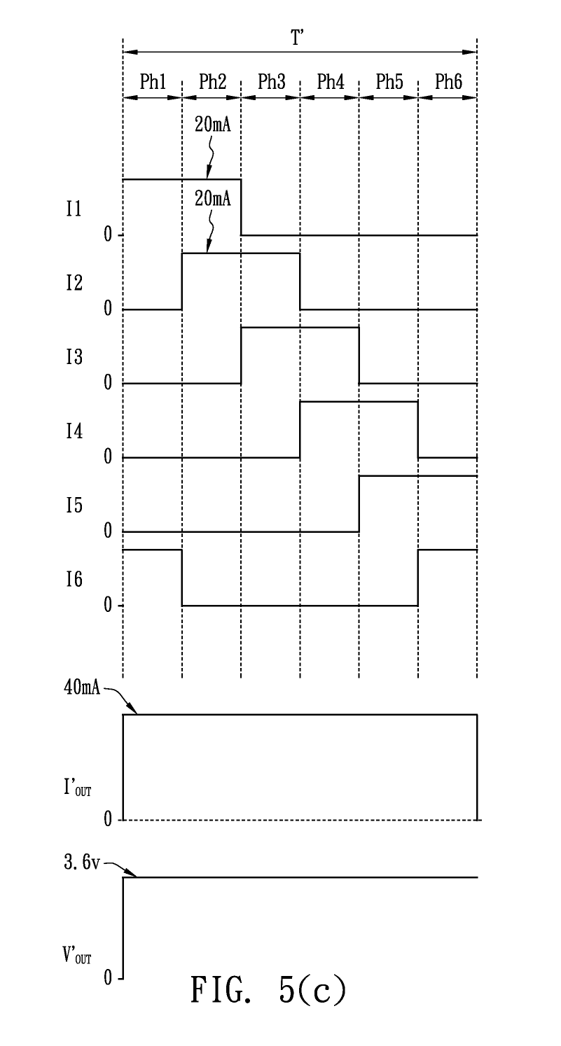

FIGS. 5(a)-5(c) are timing charts of the operating current I1-I6, and the output current I′_{OUT} and the output voltage V′_{OUT} of the boost circuit 21 under different control signal duty cycles. Referring to FIG. 5(a), the control signal duty cycle is smaller than ⅙ (about 1/12). Each operating current I1-I6 is sequentially generated in the cycle T′, and is equal to the individual operating current (i.e., 20 mA) in magnitude. Although the boost circuit 21 of FIG. 5(a) is operated in a discontinuous conduction mode (DCM), the ripple voltage of the output voltage V′_{OUT} can be reduced by increasing the frequency of the output current I′_{OUT}, thereby reducing the power loss due to charging and discharging the output capacitor C2 (in FIG. 1). Upon comparing FIG. 5(a) with FIG. 2, it is known that, the ripple voltage of the output voltage V′_{OUT} in FIG. 5(a) is significantly smaller than that of the V′_{OUT} in FIG. 2, and the frequency of the former is six times of that of the latter. Under the same duty cycle (e.g., 10%), the average output current shown in FIG. 5(a) (6*10%*20 mA) is equal to that shown in FIG. 2 (10%*120 mA). However, as mentioned above, since the output voltage of FIG. 5(a) has smaller ripple voltage, the service efficiency of the power supply of the boost circuit 21 is enhanced.

Referring to FIG. 5(b), the control signal duty cycle is ⅙. Each operating current I1-I6 is sequentially generated in the cycle T′, and is equal to the individual operating current (i.e., 20 mA) in magnitude. The boost circuit 21 of FIG. 5(b) is operated in the CCM, and the output current I′_{OUT} is continuously output, with the magnitude of 20 mA.

FIG. 5(c) shows the situation when the control signal duty cycle is larger than ⅙ (about ⅓). Each operating current I1-I6 is sequentially generated in the cycle T′, and is equal to the operating current (i.e., 20 mA) in magnitude. The boost circuit 21 of FIG. 5(c) is operated in the CCM, and the output current I′_{OUT} is continuously output, with the magnitude of 40 mA. In other words, when the control signal duty cycle is larger than ⅙, the output current I′_{OUT} is larger than the operating current of the LED (i.e., 20 mA). Under the situation of FIGS. 5(b) and 5(c), the output voltage V′_{OUT} obviously has no ripple voltages and is substantially equal to the forward voltage of the LED (e.g., 3.6 V).

In the above embodiment, six LEDs are taken as an example for illustration, but the number of the LEDs is not limited in the dimming method for the LED of the present invention. Compared with the conventional dimming method of FIG. 2, the cycle of a clock signal in the present invention is equally divided into a plurality of intervals, and a plurality of control signals corresponding to the plurality of intervals is provided, such that the pulse duration of each control signal is generated in at least one of the plurality of intervals, and an output current is generated in each interval, thereby reducing the ripple voltage of the output voltage or making the boost circuit be operated in the CCM. Therefore, the dimming method for the LED of the present invention surely improves the service efficiency of the power supply for the pulse width modulation boost circuit.

The above-described embodiments of the present invention are intended to be illustrative only. Numerous alternative embodiments may be devised by persons skilled in the art without departing from the scope of the following claims.

1. A dimming method for light emitting diodes (LEDs), applied to a pulse width modulation boost circuit, said dimming method comprising:
equally dividing a cycle into a plurality of intervals;
providing a plurality of control signals having said cycle and a pulse duration, wherein said pulse duration of each control signal is sequentially generated in said cycle; and
using said plurality of control signals to control a plurality of corresponding switches for dimming LEDs connected to the switches.

2. The dimming method for the LEDs of claim 1, wherein the pulse width modulation boost circuit is operated in a discontinuous conduction mode.

3. The dimming method for the LEDs of claim 2, wherein said pulse duration is shorter than an interval.

4. The dimming method for the LEDs of claim 3, wherein the time duration for the current flowing through each LED is shorter than the interval.

5. The dimming method for the LEDs of claim 1, wherein the pulse width modulation boost circuit is operated in a continuous conduction mode.

6. The dimming method for the LEDs of claim 5, wherein said pulse duration is longer than an interval.

7. The dimming method for the LEDs of claim 5, wherein said pulse width modulation boost circuit has an output voltage without ripple voltages.

8. The dimming method for the LEDs of claim 6, wherein said pulse width modulation boost circuit in the cycle has an output current larger than operating current of the LED.

9. The dimming method for the LEDs of claim 5, wherein said pulse width modulation boost circuit in the cycle has an output voltage substantially equal to forward voltage of an LED.

10. The dimming method for the LEDs of claim 5, wherein the pulse width modulation boost circuit outputs the current at each of the plurality of intervals.

11. The dimming method for the LEDs of claim 1, wherein each pulse duration is the same.

12. The dimming method for the LEDs of claim 1, wherein the plurality of control signals is generated by a clock signal with the cycle.

13. The dimming method for the LEDs of claim 1, wherein the plurality of control signals is generated by a time-delay circuit.

14. The dimming method for the LEDs of claim 1, wherein the pulse width modulation boost circuit is a current mode pulse width modulation boost circuit.

15. The dimming method for the LEDs of claim 1, wherein a number of the intervals is equal to a number of the control signals.

16. The dimming method for the LEDs of claim 1, wherein each of the switches is a MOS transistor.
